(19) United States
(12) Patent Application Publication
(10) Pub. No.: US 2012/0300449 A1
(43) Pub. Date: Nov. 29, 2012

(54) LED BASED HIGH-INTENSITY LIGHT WITH REFLECTOR

(75) Inventor: Craig Fields, Chicago, IL (US)

(73) Assignee: Excelitas Technologies LED Solutions, Inc., Wheeling, IL (US)

(21) Appl. No.: 13/115,469

(22) Filed: May 25, 2011

(51) Int. Cl. F21V 9/00; G06F 17/50; F21V 7/00

(52) U.S. Cl. 362/231; 362/296.01; 362/235; 700/98

(57) ABSTRACT

A light engine for a high intensity light that may be compliant with FAA or ICAO standards is disclosed. The light engine includes a first light emitting module having a light emitting diode mounted in a horizontal plane. A reflector has a reflective surface in perpendicular relation to the light emitting diode. The reflective surface is defined by combining the integrals of a required beam emission specification with the integrals of the light emitting diode. The resulting reflective curve is modified with focal length and curve based on horizontal plane position variables relative to the light emitting diode around an azimuth angle.

### TECHNICAL FIELD

The present disclosure relates to high intensity lights, and more specifically a reflector having a tailored reflector surface for LED-based high intensity obstruction lights.

### BACKGROUND

High intensity lights are needed for beacons for navigation and obstruction avoidance. For example, obstruction beacons must be capable of meeting the 100,000 cd (candela) requirements for International Civil Aviation Organization (“ICAO”) High Intensity Navigation Light Type A or B, ICAO Medium Intensity Navigation Light Types A, B, or C, or Federal Aviation Authority (“FAA”) types L-857 and L-865. In the past, lamps have used conventional strobe lights. However, such lights are energy and maintenance intensive. Recently, navigation lamps have been manufactured using light emitting diodes (LEDs). LEDs create unique requirements in order to be commercially viable in terms of size, weight, price, and cost of ownership compared to conventional strobe lights.

In the example of 20,000 cd beacons, the FAA and ICAO regulations set the following stringent requirements for beam characteristics at all angles of rotation (azimuth). Lights must have effective (time-averaged) intensity greater than 7500 candela (cd) over a 3° range relative to the horizon (elevation). Lights must also have peak effective intensity of 15,000-25,000 cd and effective intensity window at −1° elevation of 7,500-11,250 cd for the ICAO only. In particular, the ICAO standard sets a very narrow “window” of beam characteristics at −1° of elevation which must be met by beams at all angles of rotation (azimuth). Beam uniformity in all angles of azimuth is a key to meeting the ICAO requirements. The critical beam pattern requirements for 100,000cd and 2,000cd lamps are proportionally scaled from the 20,000cd specifications, although pulse rates and pulse duration vary by type of light.

Light devices must also meet the requirements of the FAA compliant version producing 60,000 cd peak intensity in 100 msec flashes. Such lights must also meet the requirements of the ICAO compliant version producing 25,333 cd peak intensity in 750 msec flashes. Ideally, lights can also be combined or configured to provide 2,000 cd red light in addition to the 20,000 cd white light for day and night time operation.

In order to achieve the total light intensity required for an FAA or ICAO compliant light using LEDs, it is currently necessary to use a large number of LED light sources. One approach pairs each LED with a reflector or other optic to achieve the required amount of collimation and still be efficient. This results in a design with a large number of optical elements each having individual LEDs and optics, resulting in a light engine of large size and volume. Another challenge with this approach is the critical alignment of the multiple optical elements such that their outputs combine to form a beam that is uniform at all angles of azimuth. Another approach uses many LEDs in groups which share individual optics, saving space. Alignment of the optical elements and LEDs remains a challenge, but with fewer such components, this alignment is less time consuming. The remaining challenge then is to most efficiently form the elevation and azimuth beams to the desired profiles using extended sources and the LED arrays.

Currently available LED based navigation lamps have stacks of multiple optical elements symmetrically with no offset between the stacks, as well as using large reflectors and multiple LEDs per reflector. While such lamps may be compliant with FAA and ICAO requirements, they typically require more than optimal number of LEDs and thus are more complex and expensive. In the particular case of creating very narrow beams with specific patterns from reflector surfaces, current tools create obstacles to efficient reflector design.

For example, Light Tools ray-trace optical modeling software uses spline 3D fits of optical surfaces from given user calculated points. This process creates a fully defined interpolated surface but exhibits waviness between points known as Runge's phenomenon, which is similar to Gibbs phenomenon in Fourier series approximations. This “waviness” in the optical reflecting or transmitting surface creates distortions in the resulting beam shape and can decrease overall efficiency by spreading light in undesired directions.

The Light Tools ray-trace optical modeling software requires that surface splines extend beyond the solid surface edges. Using the traditional method, edge conditioning of calculated points is required to satisfy the requirements and to suppress resulting spurious edge effects and Runge “waviness.” The traditional approach had used equal-lumen points to calculate eight to twenty points on the optical surfaces. This may be adequate for general illumination needs but is not adequate when developing optics for narrow intensity beams such as those required for navigation lighting. The approach was also modified so that the reflector points are calculated as a function of a instead of ‘picking off’ a and 0 points at various percents of flux as recommended by W. Elmer, “Optical Design of Reflectors,” Applied Optics, Vol. 17, March/April 1978. This was found necessary to greatly increase the resolution of the reflector points calculated to suppress Runge's phenomenon.

Thus, there is a need for an LED-based lamp capable of meeting various ICAO and FAA requirements. There is also a need for a navigation lamp that is commercially viable in terms of size, weight, price, and cost of ownership compared to existing devices using LEDs or conventional strobe lights. Another practical objective is a basic design which may be easily configured as a 100,000 cd white light engine or as a single light engine producing both 20,000 cd white beams and 2,000 cd red beams. It is desirable to produce a reflector designed to produce a narrow beam without undue amounts of trial and error iterations used with present light simulation software. It is also desirable to reduce time spent during assembly to align, test, and fasten reflectors by using larger reflector sections such that the number of required adjustments will be greatly reduced.

### SUMMARY

One disclosed example relates to a light engine for a high intensity light having a first light emitting module having a light emitting diode mounted in a horizontal plane. A reflector has a reflector surface in perpendicular relation to the light emitting diode. The reflector surface is defined by combining the integrals of a required beam emission specification with the integrals of the light emitting diode resulting in a reflector curve. The resulting reflector curve is modified with focal length and curve based on horizontal plane position variables relative to the light emitting diode around an azimuth angle.

Another example is a navigation light compliant with narrow horizontal beam requirements. The navigation light has a first plurality of light sources arranged in a circular arrangement on a mounting surface to provide light at all radial angles. A first reflector has a reflector surface in substantially perpendicular relationship to the mounting surface holding the plurality of light sources. The reflector surface is designed by combining the integrals of a required beam emission specification with the integrals of at least one of the light sources resulting in a reflector curve. The resulting reflector curve is modified with focal length and curve based on horizontal plane position variables relative to the light source around an azimuth angle.

Another example is a method of fabricating a reflector having a reflector surface to reflect light rays from a light source in a narrow beam substantially parallel to a horizontal plane. A set of beam emission requirements is integrated over a range of angles of required light emission. A model of the light source emission is integrated. A curve shape of the reflector surface is determined based on the results of the light source emission integration. The reflector surface is calculated based on functions including a horizontal plane position variable.

Additional aspects will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of an example navigation light using an LED high intensity assembly with a single reflector assembly;

FIG. 2 is a perspective view of an example LED high intensity light assembly used in the navigation light of FIG. 1;

FIG. 3 is a close up perspective view of one segment of the LED high intensity light assembly in FIG. 2;

FIG. 4 is a side view of the LED high intensity light assembly in FIG. 2;

FIGS. 5A-5C are ray trace diagrams for one design of the reflective surface of the reflector assembly segments of the light assembly in FIG. 2;

FIG. 5D is a ray trace diagram for another reflector design which alters the ray ordering from the designs in FIGS. 5A-5C;

FIG. 5E is a ray trace diagram for a double mapping pattern design choice for the reflective surface of the reflector assembly segments of the light assembly in FIG. 2;

FIG. 5F is a ray trace diagram for a reflector with a pure conic or parabolic surface;

FIG. 6 is a flow diagram of the general process of designing the shape of the unique reflective surface of the light assembly in FIG. 2;

FIGS. 7A-7B are integration graphs used in the process of design of the reflector surface in FIGS. 5A-5C;

FIG. 7C are integration graphs used in the process of designing a double mapping pattern for the reflector surface shown in FIG. 5E;

FIG. 8A-8C are intensity graphs over different elevation angles of reflective surfaces designed using the techniques described herein;

FIG. 9A is an intensity graph of a reflective surface designed incorporating a horizon dimension function in the design;

FIG. 9B is a reflector Z profile of the reflective surface in FIG. 9A;

FIG. 9C is graph of Z profiles at fixed x coordinate points after adding a horizontal coordinate variable to the design technique; and

FIG. 10 is an intensity graph of reflectors of a light engine having staggered light emission assemblies to offset ripple.

While these examples are susceptible of embodiment in many different forms, there is shown in the drawings and will herein be described in detail preferred examples with the understanding that the present disclosure is to be considered as an exemplification and is not intended to limit the broad aspect to the embodiments illustrated.

### DETAILED DESCRIPTION

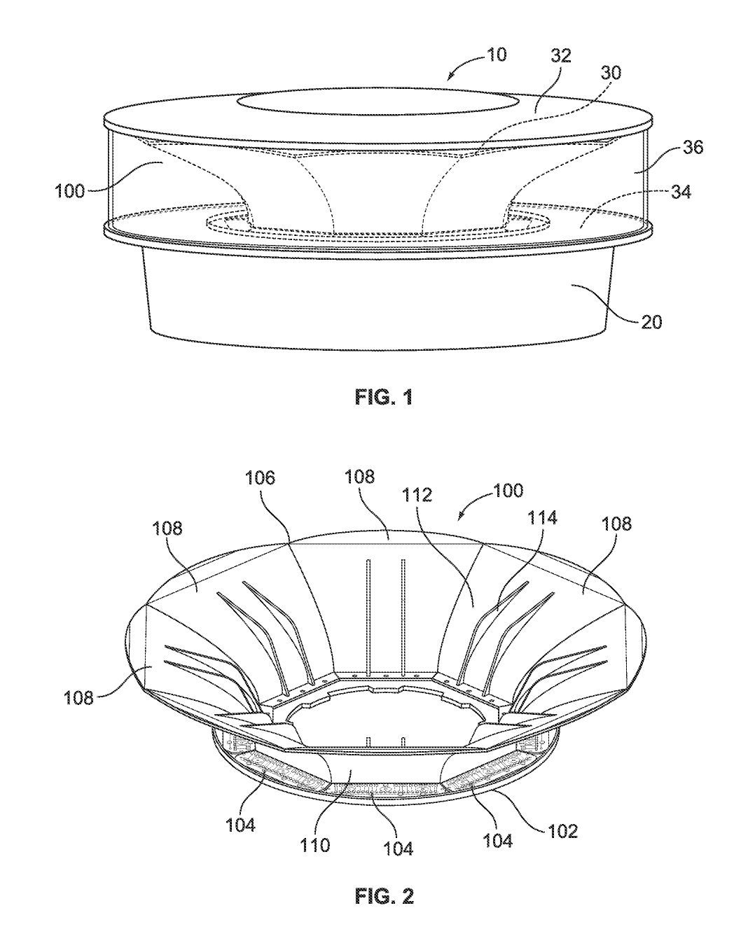

FIG. 1 shows an example high intensity navigation light 10 providing focused narrow beams in the horizontal plane at 360 degrees compliant with desired standards such as those of the FAA or ICAO. The navigation light 10 has a base assembly 20 and a light module 30. The light module 30 has a top plate 32 and a bottom plate 34 that are both circular and hold a cylindrical transparent cover 36. The light module 30 encloses a high intensity LED-based light assembly 100.

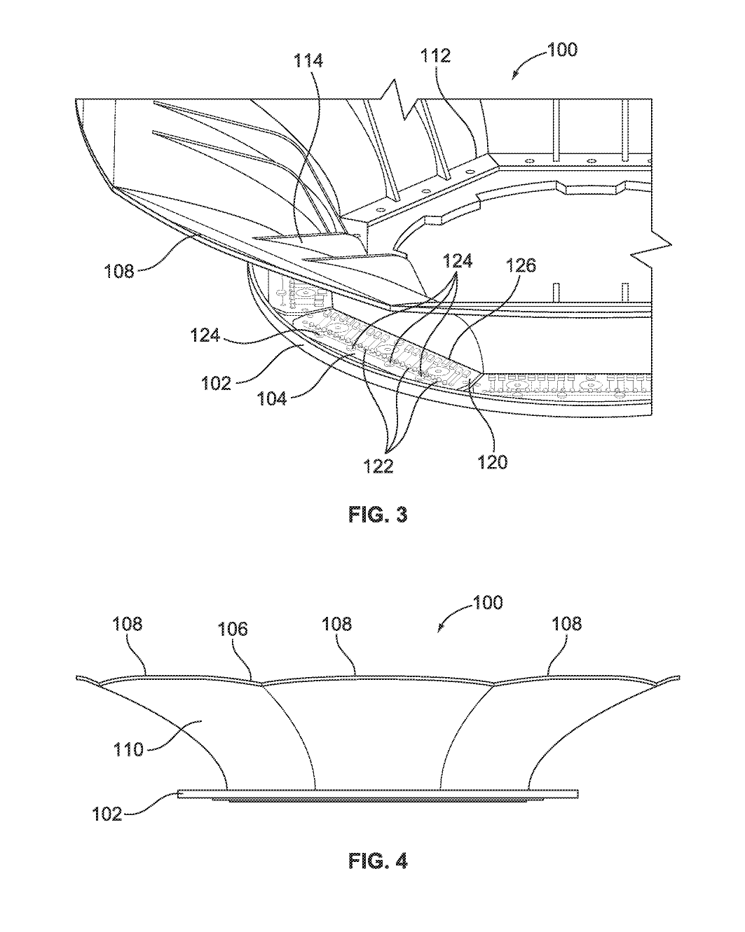

As shown in detail in FIG. 2, the LED based light assembly 100 may be used as part of an aircraft beacon obstruction light such as the navigation light 10 and may emit light rays compliant with applicable FAA and ICAO standards such as ICAO High Intensity Navigation Light Type A or B, ICAO Medium Intensity Navigation Light Types A, B, or C, or FAA types L-857 and L-865. The high intensity LED-based light assembly 100 has a base 102, a series of light emission modules 104 and a reflector assembly 106. The reflector assembly 106 has a series of eight symmetrical reflector components 108 each having a curved reflector surface 110. In this example, the eight reflector components 108 are combined to form a ring-shaped reflector 111. Each of the curved reflector surfaces 110 reflect light emitted from the light emission modules 104 and combine the emitted light to a uniform beam output around the entirety of the light assembly 100. The base 102 is circular in shape and mounts the light emission modules 104 and the reflector assembly 106.

Each of the reflector surfaces 110 of the reflector components 108 has a unique surface geometry determined by the methods described herein to comply with desired narrow beam requirements. The reflector surfaces 110 are arranged in perpendicular relation to the surface of the base 102 that holds the light sources of the light emission modules 104. The reflector surfaces 110 are coated with aluminum or other highly reflective material. The reflector components 108 also include an opposite interior surface 112 that includes a series of ribs 114 that serve to stiffen the reflector components 108 and to aid molding the reflector components 108. As shown in FIG. 2, there are fewer reflector segments then light emitting devices such as LEDs thereby simplifying assembly of and reducing costs of production of the light assembly 100.

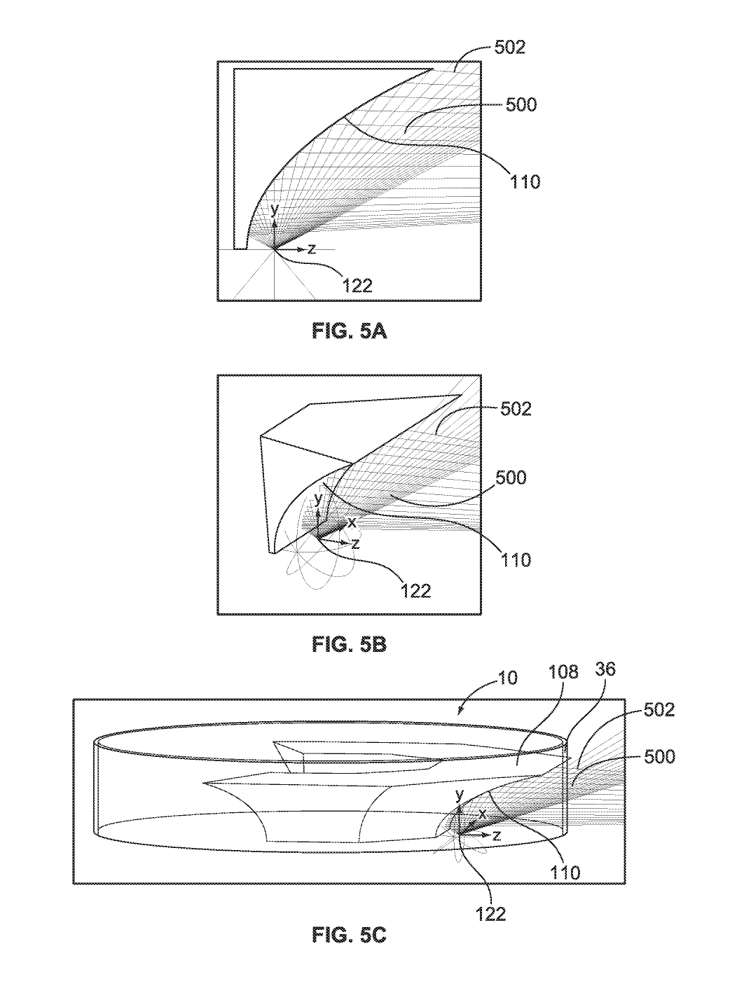

FIG. 3 shows a close up perspective view of one of the light emission modules 104 and the corresponding reflector component 108. In this example, there are eight light emission modules 104 that combined allow light to be emitted uniformly from 360 degrees around the light assembly 100. Each of the light emission modules 104 has one or more light sources such as LEDs and a reflector element which is part of the reflector assembly 106. In this example, the LEDs are high-brightness white or red LEDs whose main beam is approximately perpendicular to the final output beam axis and the LEDs are arrayed in an approximately linear fashion relative to the side of the base 102. The LEDs are arrayed relative to the reflector components 108 for the emission of a light beam compliant with FAA or ICAO standards.

The light emission module 104 includes a circuit board 120 that has a series of white LEDs 122 and a series of red LEDs 124. In this example, the LED 122 is a high-brightness white LED such as an XLamp XP-G series LED available from Cree. In this example, there are four total red LEDs 124 which are each mounted apart from each other on the circuit board 120. There are partial rows of white LEDs 122 which are interposed between the red LEDs 124. In this example, four white LEDs 122 are on either end of the light emission module 104, and four white LEDs 122 are between each of the red LEDs 124. Thus, there are a total of 20 white LEDs 122 on the light emission module 104. In this example the eight light emission modules 104 include a total of 32 red LEDs 124 and 160 white LEDs 122. Each LED 122 or 124 is coupled to a respective zener diode chip 126 that provides electrical protection and bypass to the LED 122 and 124. The zener diode chips 126 are mounted on the circuit board 120.

Of course it is to be understood that different numbers of optical elements and circuit boards may be used. The circuit board 120 transfers heat from the LEDs 122 and 124 to the base member 102 and direct electrical power to the LEDs 122 and 124 via power supplies (not shown) mounted in the interior of the base 102 in FIG. 1. In this example, the circuit board 120 is a thermally conductive printed circuit board (PCB), having a metal core of aluminum or copper. The LEDs 122 and 124 are preferably attached to circuit board 120 using solder, eutectic bonding, or thermally conductive adhesive.

Heat in the base 102 from the circuit boards 120 may then be conducted to the base 20 or transferred by convection to the internal enclosed air. Heat may also be removed convectively from the base 102 by using a circulating fan (not shown) in the center of the reflector assemblies 108.

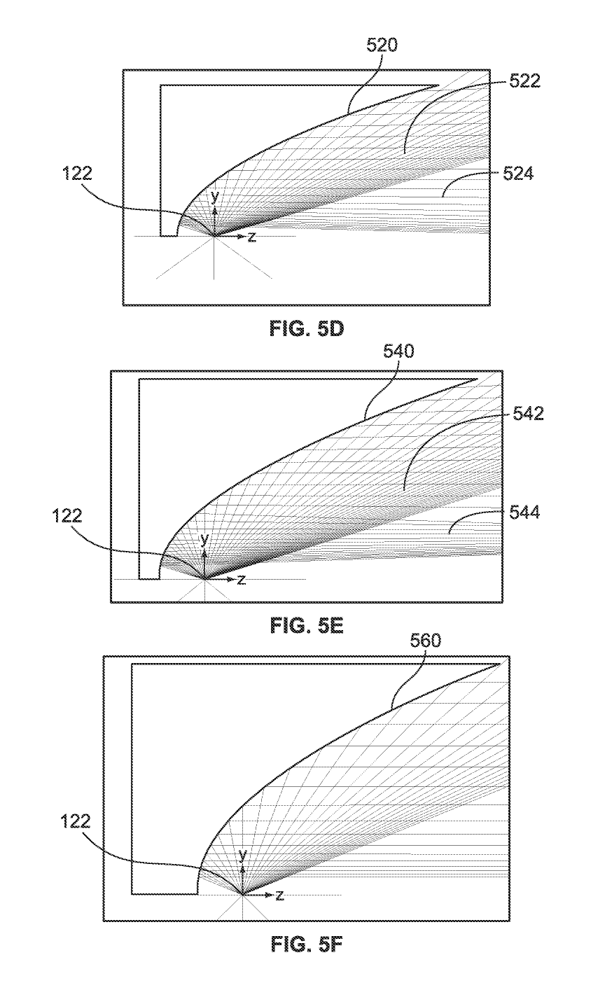

FIG. 4 shows a side view of the light assembly 100. As shown in FIG. 4, the vertical orientation of the LED 122 and 124 relative to the plane of the base 102 causes the majority of the light from the LEDs 122 and 124 to be reflected by the reflecting surface 110 before exiting the light assembly 100. This ensures that the majority of the light from the LEDs 122 and 124 has been controlled by a unique surface geometry such as that of the reflector surface 110 as will be explained below. The reflector surface 110 is designed to form the vertical (elevation) collimation required and to form the desired horizontal (azimuth) beam that is compliant with requirements such as FAA or ICAO standards.

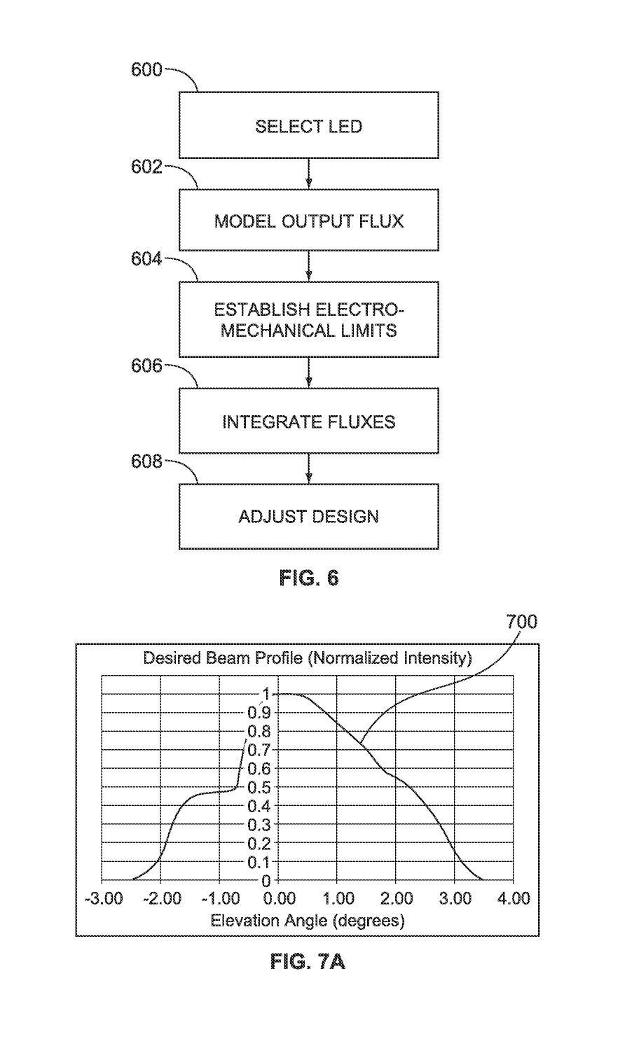

FIGS. 5A-5C are ray trace diagrams showing the emission of light rays from the light assembly 100. FIG. 5A shows a two-dimensional ray diagram of light rays 500 from an LED such as the LED 122 in a vertical direction reflecting on the reflector surface 110 of one of the reflector components 108. As will be explained below, the light rays 502 near the top of the reflector surface 110 are directed slightly downward as a part of the ray ordering design. FIG. 5B shows a three dimensional diagram of the reflector component 108 in relation with the base 102 and the emission of light rays. As shown in FIG. 5B, the light rays 500 reflected from the reflector surface 110 are directed generally in a horizontal direction. The light rays 502 at the edge of the reflector surface 110 are directed by the reflector surface design at a relative down angle to the horizontal plane to reinforce the beam.

FIG. 5C is a light ray diagram of the navigation light 10 including the transparent cover 36 installed over a section of the light assembly 100. The light ray diagram in FIG. 5C shows that the transparent cover 36 affects the path of the light rays 500 emitted from the LED 122 and reflected from the light reflector surface 110 of the reflector segment 108.

FIG. 5D shows the ray trace diagram and ray ordering of a reflector surface with an alternative and poor choice of ray ordering for a finite width source. FIG. 5E shows the ray trace and ray ordering of a reflector surface designed with a double mapping. FIG. 5F shows the ray trace diagram and ray ordering of a pure conic, or parabolic reflector surface 560 which does not use the reflector design methods described herein. The pure conic or parabolic reflector surface 560 in FIG. 5F causes an uncontrolled ray ordering which results in a less than optimum surface profile with no direct control of reflector subtended view angle in relationship with output beam shape. This less than optimum approach may fail to meet optical requirements, or requires other measures to compensate for poor ray ordering. The addition of f(y) terms to the conic surface does not give any practical ray ordering control to the designer.

As explained above, the methods described herein for the design of the reflector surfaces 110 in FIGS. 2-4 require mathematical models for all design input and intermediate elements or results. These mathematical models may be implemented either as explicit algebraic or trigonometric expressions where convenient, or may necessarily be modeled as data point sets which may be interpolated by piece-wise linear or polynomial methods where intermediate points are needed to complete calculations for adequate surface mesh spatial and angular resolutions.

Use of either a cylindrical or spherical coordinate system is advantageous for solutions based on the following two classes of source (LEDs) models: a linear extended source with cylindrical symmetry; and a rotational symmetrical source with rotationally symmetrical beam.

As explained above, the optical or reflective surface of the reflector has a calculated 3D surface with one or more profiles distributed (but not uniformly extruded) along the x longitudinal direction or distributed (but not uniformly swept) around the azimuth angle, Φ.

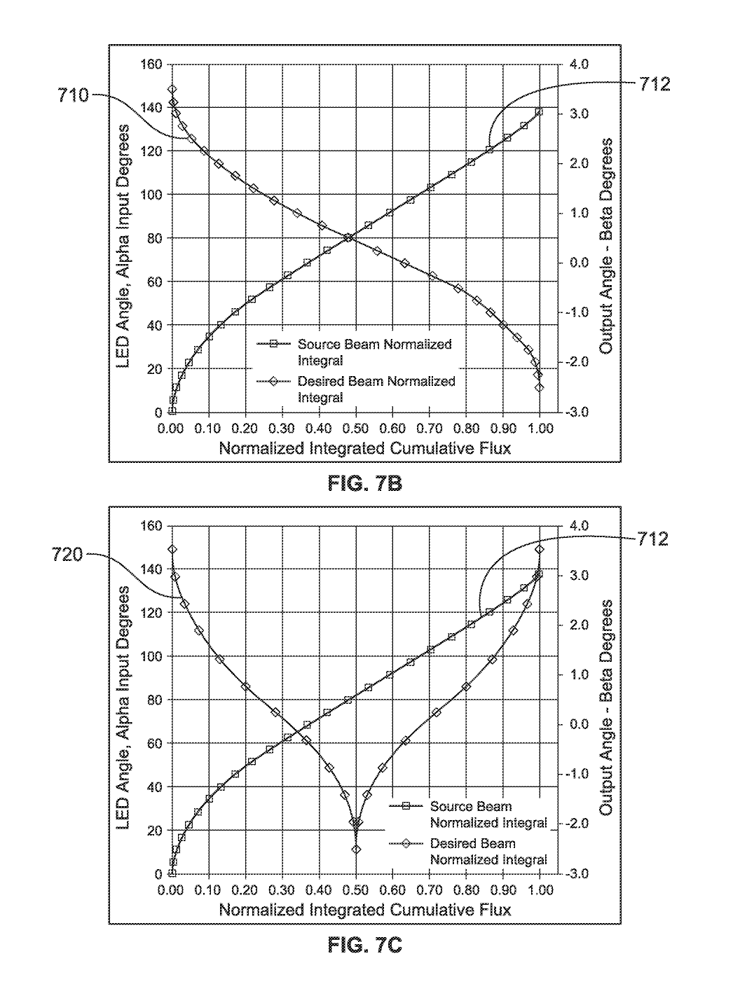

FIG. 6 is a flow diagram for the process for designing the reflector surface 110 of the reflector assembly 106. First, the LEDs 122 or 124 are selected (600). The LED output flux of the selected LED is modeled in terms of a coordinate system (602). Opto-mechanical constraints such as reflector focal distances and dimensional extents of the physical design are then established (604). The description of the desired beam pattern is selected in terms of the chosen coordinate system. The numeric integration of source and LED cumulative fluxes is performed incorporating functions of the x location or azimuth angle along the longitudinal axis of the reflector or the azimuth angle of the beam output (606). The selection of desired ray ordering and mapping patterns are combined in this step. Design inputs and output vertical and horizontal beam patterns are then adjusted to compensate for finite source size and the affects of arraying (608). The adjustments may be performed by an iterative process making adjustments for the horizontal or longitudinal beam pattern output.

The selection of and modeling of LEDs (600) involves considering criteria such as size, flux, efficacy, cost, and optical properties. Selection is a matter of engineering and commercial tradeoffs. The LED is then characterized based on measurements and/or manufacturer's data sheets. A suitable parametric function may then be selected to best model this data for numerical integration.

The selection of opto-mechanical constraints (604) include consideration of the initial conditions necessary to perform numerical integration that must be selected. This includes the desired “focal length” of the reflector design. The term “focal length” is defined as the closest distance between the light source such as the LED 122 and the designed reflector surface 110 of the corresponding reflector component 108 as shown in FIGS. 2 and 3. It is necessary to define the numerical integration from a starting point, which includes the distance and position of the reflector surface 110 relative to the LED 122. The last integrated point of the reflector is defined by the angle vector where it is desirable for the reflector to stop. In the orientation shown in this example, a terminating source angle of 180° is ideal in order to capture all light along the y-z plane. However, since this would result in an impractical infinite reflector, a tradeoff must be made wherein the terminating angle is less than 180°.

The integration step (606) is quick if automated, so the resulting height and depth dimensions of the reflector surface 110 may be easily adjusted against the percent of cylindrical flux captured.

An important design choice is the ray ordering of the output beam which determines how the data is combined and finally integrated. The choice may be based on purely optical performance or mechanical constraints where exiting rays must mechanically clear obstructions in the light assembly 100 and corresponding external components.

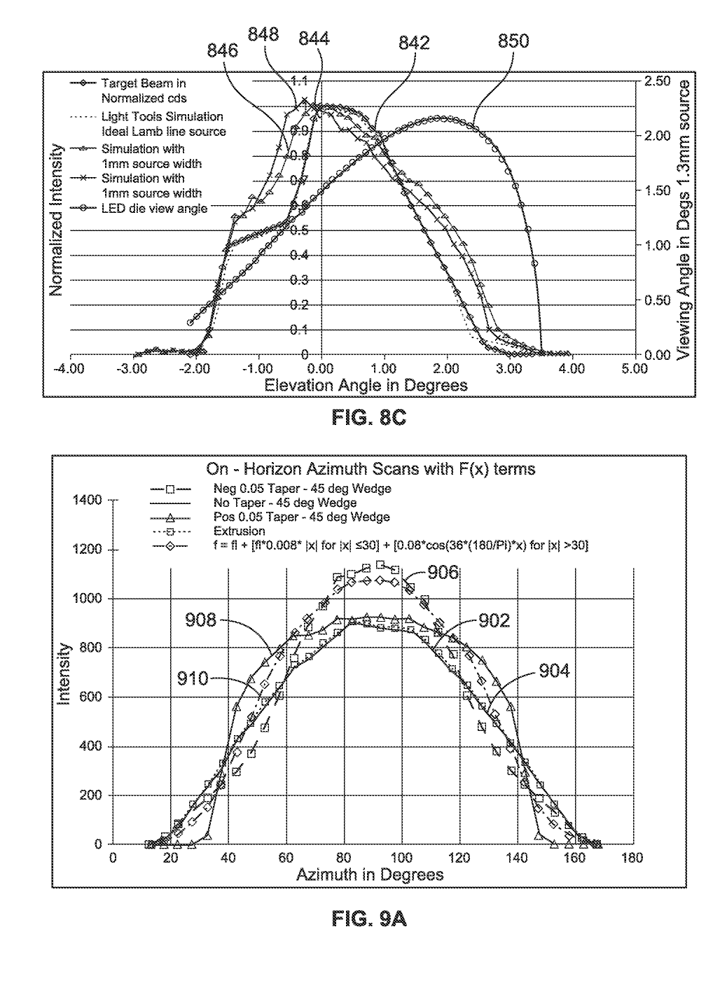

If an optically poor choice is made as shown in a reflector surface 520 shown in FIG. 5D, the output beam represented by ray traces 522 and a profile 808 in FIG. 8A will not be very close to the desired profile and adjustments to the desired beam shape may not be sufficient to achieve the desired light output. The profile 808 in FIG. 8A is the result of such a poor selection which results in rays near the bottom edge of the reflector surface 520 such as the rays 524 to begin angled downward and below the horizontal plane as shown in FIG. 5D. Because the desired output beam for the ICAO standard also has the largest intensity slopes and shelf details at minus one degree elevation and in the region below the horizon, but the portion of the reflector which is the closest to the LED also has the larger and poorer viewing angle 812, the rapid rise in intensity and the shelf details are not reproduced well in the profile 808. In this result, a new ray ordering must then be tried to conform the reflector surface 520 to the design requirements.

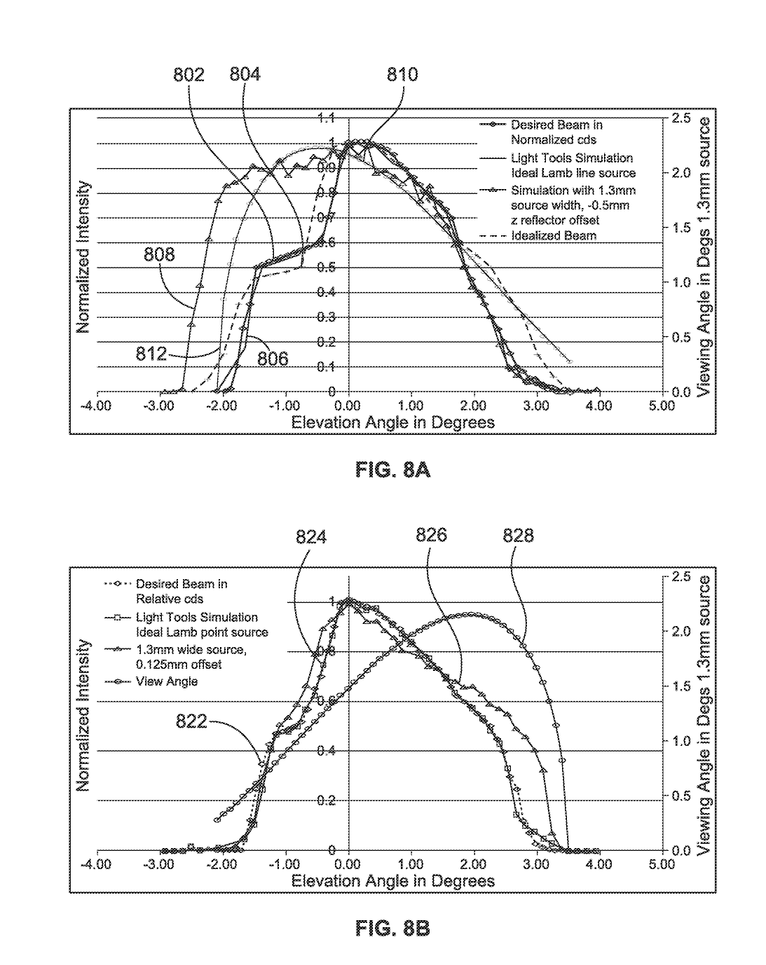

Returning to FIG. 6, the integration phase (606) begins with a desired beam profile based on design requirements. For example, FIG. 7A shows a beam profile graph of an idealized ICAO vertical beam trace 700 from a compliant navigational light. The intensity of the beam is the vertical axis while the elevation angle is on the horizontal axis. As may be shown in FIG. 7A, the ideal beam is at its greatest intensity at a 0 degree elevation angle (an azimuth of zero degrees). The points of the ideal beam profile are integrated and the cumulative flux curve points of a modeled light source are also integrated.

The integrated fluxes of the output beam and LED source are shown in FIG. 7B. FIG. 7B is a graph showing plots of the preferred mapping for this design case, with an output flux integration curve 710 (diamond symbol points) for the desired source beam starting at the positive or above the horizon edge of the beam. This corresponds to the innermost LED rays, or low value source or “Alpha” angles mapping to above the horizon. The integration of the model of an actual source beam results in a curve 712. The integration of an ideal beam output in FIG. 7B produces the curve 710 representing the normalized flux of an ideal beam. The source cumulative integrated flux in FIG. 7B is the result of the primarily lambertian distribution pattern of the particular LED source chosen. It must be characterized or modeled for intensity versus angle as the output, Iᵥ source (α). The cumulative flux curve is then obtained through vertical correspondence of the points on the curves 710 and 712 in FIG. 7B.

By this process, the reflector shape may be partly determined based on use of the ideal beam requirements and the model of the light source as shown by the curves 710 and 712 in FIG. 7B. This technique is more efficient as it does not require blind parametric iterations to the surface of the reflector and subsequent ray tracing to optimize the reflective surface. A further design technique, as will be explained below, incorporates the position in the horizontal plane or the azimuth angle by determining proper adjustments in the horizon direction, x.

FIG. 7C shows the results of integration of the normalized desired beam in a curve 720 where the ray ordering is double mapped. The same source beam integration curve 712 is used as in FIG. 7B for modeling the light source. The output beam no longer has the uniqueness properties of an algebraic function with respect to output angle, Beta, on the second vertical axis. For any output angle, there are two possible values of intercepted flux. FIG. 7C is an example showing that a smooth continuous surface may be derived from the design method described above. The resulting reflector surface has two sections forming a complete beam of the desired shape. A resulting reflector surface 540 is shown in FIG. 5E which is a ray trace diagram showing a series of downward exiting light rays 542 which are confined to the central portion of the reflector surface 540, with a series of upward light rays 544 at the extremes of the reflector edges. This is in contrast with a single mapping design of FIG. 5A or the unknown or controlled mapping of a conic section shaped reflector surface 560 as shown in FIG. 5F.

The calculation of incremental fluxes is determined by the following process. The flux is represented as

Luminous Flux(α)=Luminous Intensity(α)·solid angle or Φᵥ=IᵥΩ where Φᵥ is the flux defined as Iᵥ·Ω, where Iᵥ is the intensity, and Ω is the solid angle. Ω is=∫_{φ} ∫_{θ} sin(θ)·∂θ·∂φ. This simplifies in the special case of a linear source and beams in cylindrical coordinates to the form:

Φᵥ(α)=∫^{α}Iv source (α)·∂ α a plotted against normalized flux.

Likewise the output vertical beam, Iv beam (−β), is integrated using solid angles and the cumulative flux results plotted versus the normalized total flux where Beta or β is related to the negative of the output beam elevation angle and either may be referred to loosely as Beta with the understanding of their sign relationship. Both integral results are used as tabulated data which may be interpolated for intermediate values.

The numerical integration of points of equal-cumulative flux is performed as follows. The reflector surface is calculated using the equation provided by W. Elmer, “Optical Design of Reflectors” Applied Optics, Vol. 17, March/April 1978 hereby incorporated by reference, as follows:

ln (r/f)=∫ tan ((α−β)/2) ∂ α

In this equation, r is the radial distance from the LED or source to the reflector surface, f is the focal length or initial radial distance from the LED source to the reflector surface, α is the angle of the incident ray with respect to the negative output optical axis and β is the angle between the corresponding reflected ray and the output optical axis. The calculated points are points of tangency. CAD software does not interpret point sets with this assumption.

Formation of narrow, tightly controlled beams from a reflector designed using the technique and the necessity of using fine input integrals for source and beam are required. The use of finer a angular resolution as the controlling parameter for reflector points calculated during the final integration is also required.

Simulation of an initial base design involves the calculated mesh of points being translated into an acceptable format for commercial ray trace software. As required the reflector surface may be truncated and replicated to form the desired design. Suitable light source models are added and positioned. It is also useful to initially simulate a light source representing an ideal source with near zero width. Ideal sources simulate much faster than LED ray file models and are useful for evaluating the design. After simulation, intensity results can be compared against the input design requirements. Supplemental calculations such as viewing angle for finite size sources should be calculated and combined to assist in understanding the regions of intensity deviation from the design input.

FIGS. 8A-8C are graphs of example initial simulation results from light reflected from reflector surfaces fabricated according to the above design process. Intensity results using ideal linear sources which do not closely match input requirements may indicate systematic design problems, such as insufficient surface mesh resolution, Runge' s phenomena, spline fit errors at reflector edges, insufficient number of traced rays, or positional errors. These issues should be resolved before considering the finite source model intensity results.

Adjustments of design inputs and output vertical and horizontal beam patterns are necessary to compensate for finite source size and the affects of arraying. The simulation results in FIGS. 8A-8C are useful for intermediate design steps and results which are involved in the design and adjustment process after the initial curve is determined.

FIG. 8B is a chart of the input desired beam intensity, lambertian source simulation output, and a lambertian source of 1.3 mm width. The horizontal axis shows the elevation angle in degrees and the vertical axis shows the viewing angle (also known as a subtended angle) of a 1.3 mm source from the point of view of the reflector surface in FIG. 5A. The desired beam is based on an idealized ICAO standard and is shown as a dotted line 822 with diamond markers. The simulation beam using a 120 mm long ideal line source is shown as a dashed line 824 with square markers. There is good correspondence between the input and output of this design, but it is necessary to adjust the number of input design points and output points of the reflector surface to eliminate spurious errors caused by the discretization process and suppress the surface spline fit of the simulation software.

A solid line 826 with triangle markers shows the simulated output from the light source and reflector when the source size is widened to 1.3 mm to simulate a row of high brightness LED devices. The relative position of the reflector to the light source must be adjusted to re-aim the peak, in this case 0.125 mm. The simulation shows that the output beam is wider than the design input as should be expected from the result of using a finite source size in the z dimension. A solid line 828 with circle markers shows the viewing angle or subtended angle of the source with respect to the reflector. This line 828 indicates the angular spread of the beam as if there were a pinhole aperture on the reflector surface. At any given point the reflector may be considered as a flat minor with zero diameter. A mirror segment defined in this manner will preserve the angular spread of the light falling on it, which in this case is a finite/extended source at a near field distance. This provides an indication of the source size error on the output beam from the reflector. FIG. 8B shows a desirable design of a reflective surface due to the fit of the maximum intensity of the simulated output curve 826 with the maximum intensity of the viewing angle curve 828.

FIG. 8A is a graph showing the result of a less desirable optical ray ordering such as the ray trace shown in the reflector surface modeled in FIG. 5D. As with FIG. 8B, a line 802 (diamond markers) represents a design target beam compliant with applicable standards such as ICAO standards shown in FIG. 5A. A solid line 806 (no markers) represents the simulation of a lambertian ideal linear light source with zero width via a simulation tool such as Light Tools. A solid line 808 (triangle markers) shows the simulated output when the source size is widened to 1.3 mm with a −0.5 mm z offset. A solid line 810 with circle markers shows the viewing angle of the source with respect to the reflector.

The broad and distorted beam shape of curve 808 in FIG. 8A is the result of the finite extent or width of the light source as viewed from points along the reflector surface. The viewing angle on the reflector surface represents the angular spread of light arriving from both the nearest and farthest points of the light source. The peak values of viewing angle 810 in this case occur in the negative beam angle of the beam where the beam has the most detail. The peak values are shown by the sharp cut-off at 0° elevation and a narrow “shelf” at −1° elevation as shown by the target desired beam line 802, the simulation line 808 and the idealized beam line 804. This detail is completely wiped out and smeared due to the angular extents of the light rays from the finite source width as shown by the simulated output line 808. The required positional correction for the finite source is also much larger, 0.5 mm vs. 0.125 mm in the preferred ray ordering design and is in the opposite direction with more distance between the LED and the reflector.

As explained above, a desired design of a reflective surface shows a very high correspondence with the input target beam for the ideal case of a zero width source in FIG. 8B. The simulation graphs in FIGS. 8A and 8B demonstrate that the ray ordering choice and effect are dependent on the relative finite size of the source. FIG. 8A also indicates a different required target shape than FIG. 8B with a much wider and higher shelf region at −1° elevation to attempt to compensate for the ray ordering choice.

FIG. 8C shows graph showing the light output of a reflector design where the desired beam pattern has been modified from the ideal ICAO target values, and the representative zero azimuth elevation profiles for ideal, 1 mm and 1.3 mm source widths are adjusted in position for best overall vertical aim. The modifications are made to the design target based on initial simulation results which indicate how the target beam must be modified to get the desired beam and when fully arrayed with a finite source size. As with FIG. 8A, a line 842 (diamond markers) represents an ideal beam compliant with applicable standards such as ICAO standards shown in FIG. 5A. A dotted line 844 represents the represents the simulation of an ideal zero width linear lambertian light source via a simulation tool such as Light Tools software. A solid line 846 (triangle markers) shows the simulated output when the source size is 1.0 mm. A solid line 848 (x markers) shows the simulated output when the source size is widened to 1.3mm with a −0.125 mm z offset. A solid line 850 (circle markers) shows the angular extents of the source with respect to the reflector surface 110.

This simulation as demonstrated in FIGS. 8B and 8C show that the ICAO target beam as shown by the line 842 may be closely met with suitable adjustments to the target beam and reflector position to compensate for finite source size effects.

The above technique may also be modified to create a focal length and angle between the corresponding reflected ray and the output optical axis functions based on the location, x on the longitudinal axis (azimuth) direction, respectively. In order to do so, the output beam, Iᵥ (β) is integrated yielding a β function that may be also be designed as functions of the x location along the longitudinal or horizontal axis of the reflector or along the Φ output azimuth angle of the system Iᵥ. These functions are designated as f(x, Φ) and β(x, Φ). The focal distance, f, may be a function of the x-coordinate along the longitudinal axis of the reflector and/or along the angular position, Φ, of the reflector. These functions f(x, Φ) and β(x, Φ) may be used as the design input data set to change the azimuth distribution of each reflector section to affect collimation or dispersion along the azimuth direction as needed. A diffusion film may be used to further smooth output azimuth ripple. Beam spreading and control is somewhat limited along the azimuth or longitudinal direction, because the light is not collimated in that direction, does not come from a localized area or point, and is subject to Etendue limitations.

As needed, the selection and design of optimized variables, β(x, Φ) and or f(x, Φ) to affect azimuth beam spread for desired affects for more collimation or less collimation may be considered in combination with multiple sections of reflectors or as a single general illumination reflector system. Adding the variables, β(x, Φ) and or f(x, Φ) may change the optimum relative distance of the light source to the reflector when the source is a significant finite dimension (width) and the amount of required collimation or precision in the beam aim is high.

Specifically the function f( ) in relation to the horizontal may be described as an independent or arbitrary function in x and Φ:

f(x, Φ)=fl+Σ kₙ·Abs(x^{m})+Σ(sⱼ·x^{k})+u(x, y)+v(Φ, y)

where k and s are design coefficient sets and n and j are index terms from 0 to 20 and m and k are real number exponent terms ranging from −20 to +20, and u(x) and v(Φ) are arbitrary functions of x and Φ. In this example, the function f(x, Φ) is a function of focal length, fl, but added terms of f(x, Φ) may be independent of the focal length, fl. The function can also include non-linear operations such as absolute value as shown in the example.

The function f( ) can also be broken into any number of sub-sections along the length of the reflector, for example with twenty sub-sections:

f(x, Φ)=Σ fₙ(x, Φ) for n=0 to 20

where:

$${f}_{0} ( x , Φ ) = fl + \sum {k}_{n 0} \cdot Abs ( {x}^{m 0} ) + \sum ( {s}_{j 0} \cdot {x}^{k 0} ) + {u}_{0} ( x , y ) + {v}_{0} ( Φ , y )$$

$$for 0 \leq x < {x}_{1}$$

$${f}_{1} ( x , Φ ) = fl + \sum {k}_{n 1} \cdot Abs ( {x}^{m 1} ) + \sum ( {s}_{j 1} \cdot {x}^{k 1} ) + {u}_{1} ( x , y ) + {v}_{1} ( Φ , y )$$

$$for {x}_{1} \leq x < {x}_{2}$$

$$…$$

$${f}_{20} ( x , Φ ) = fl + \sum {k}_{n 19} \cdot Abs ( {x}^{m 19} ) + \sum ( {s}_{j 19} \cdot {x}^{k 19} ) + {u}_{19} ( Φ , y )$$

$$for {x}_{19} \leq x \leq {x}_{max}$$

Specifically the functions u(x, y) and v(Φ, y) could be polynomials, trigonometric functions, or cyclic functions such as:

u(x)=g(x)·cos^{R} (B·x)+h(x)·sin^{Q} (D·x) or u(Φ)=g(Φ)·cos^{R} (B·Φ)+h(Φ)·sin^{Q}(D·Φ)

Where g( ), and h( ) represent arbitrary amplitude modulation functions and B, D, R, and Q are real numbers.

The effectiveness of a given function β(x, Φ) or f(x, Φ) is typically a result of the relative lengths or ratio of the source to the reflector. For example, a cyclic function is not effective if the linear array of LEDs is a substantial portion of the length of the reflector, but would be more effective for a single LED or a shorter array.

In this example, more than 35 points are used and approximately a minimum of 55 points of the source and beam integrals to get an accurate input-output mapping of the narrow and idealized ICAO beam. Resolution of less than 1° or around 0.5° in the α source angle for surface point calculation was needed to sufficiently approximate curve tangency and suppress Runge's phenomenon for the narrow ICAO beam. This corresponds to a minimum of approximately 280 y-coordinate points per x-coordinate on the reflector surface.

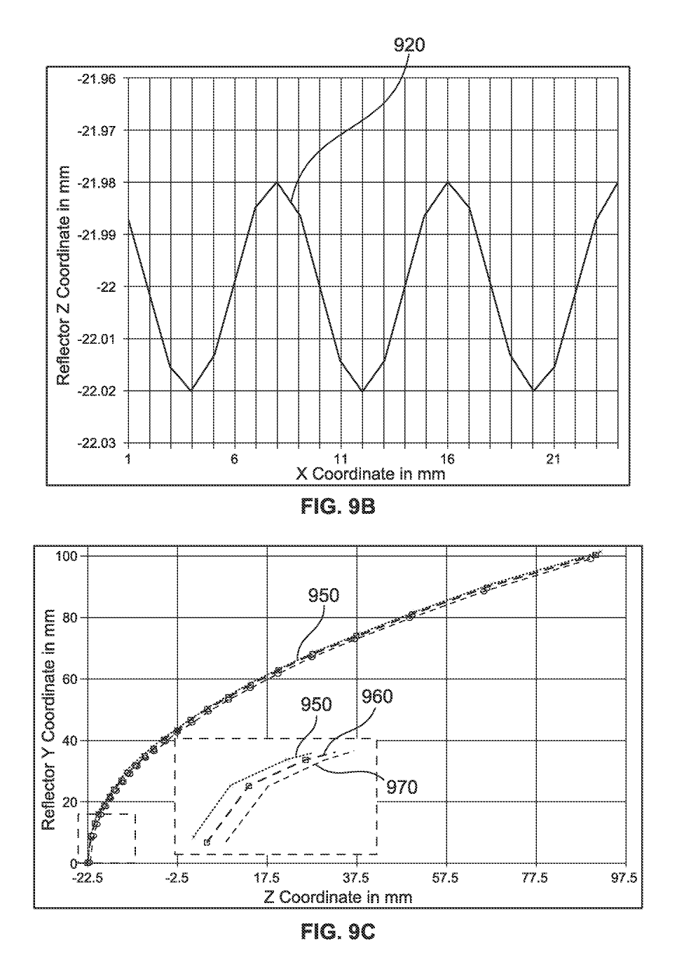

FIG. 9A compares azimuth scans using several forms of f(x), to baseline geometries without an f(x) function. Various functions may be tried and the effects on azimuth evaluated for best results. A baseline geometry output curve 902 (dotted line with square markers) has a uniform or extruded reflector surface profile determined by numerical integration as explained above with no geometrical wedge added for producing a circular array assembly as shown in FIG. 5C. Adding geometric clipping to form the wedge is required for a space-efficient light engine because of the segments 108 needed for the circular assembly 100 shown in FIGS. 2 and 4. A solid line 904 represents the baseline geometry with the addition of a wedge shape, as shown, the line 904 lays on top of the baseline curve 902.

However, the reflector must also be wedged from top to bottom of the reflector due to the geometry of the light emitting assembly 100 in FIG. 2. A line 906 shows the output of a reflector incorporating a specific function, f(x) expressed as a tapered f(x):

f(x)=fl+k₁·Abs(x)

where k₁=−0.05 mm/cm in this example. The result on the horizon scan is relatively higher peak value intensity in the center showing more collimation possible with the added f(x) term. A curve 908 (solid line with triangle points) is the case with k₁=+0.05 mm/cm, resulting in a flatter and broader intensity azimuth scan. A final dash-dot line (diamond markers) 910 shows another form of f(x) with terms defined in regions of x defined by

f(x)=fl+[k₁·Abs(x for x≦30]+[k2·cos (k₃·x)for x>30 ]

FIG. 9B shows a trace 920 of a reflector profile, z, plotted against x-coordinates with the addition of a cyclical term f(x) to the focal length. In this case, the amplitude of the fluctuations is ±0.02 mm.

FIG. 9C is a graph of profile curves 950, 952 and 954 that show vertical slices of a reflector designed with a f(x) taper such as the output beam profile shown in 9A. The profile curves are neither x projected linear translations, or rotations of a single profile.

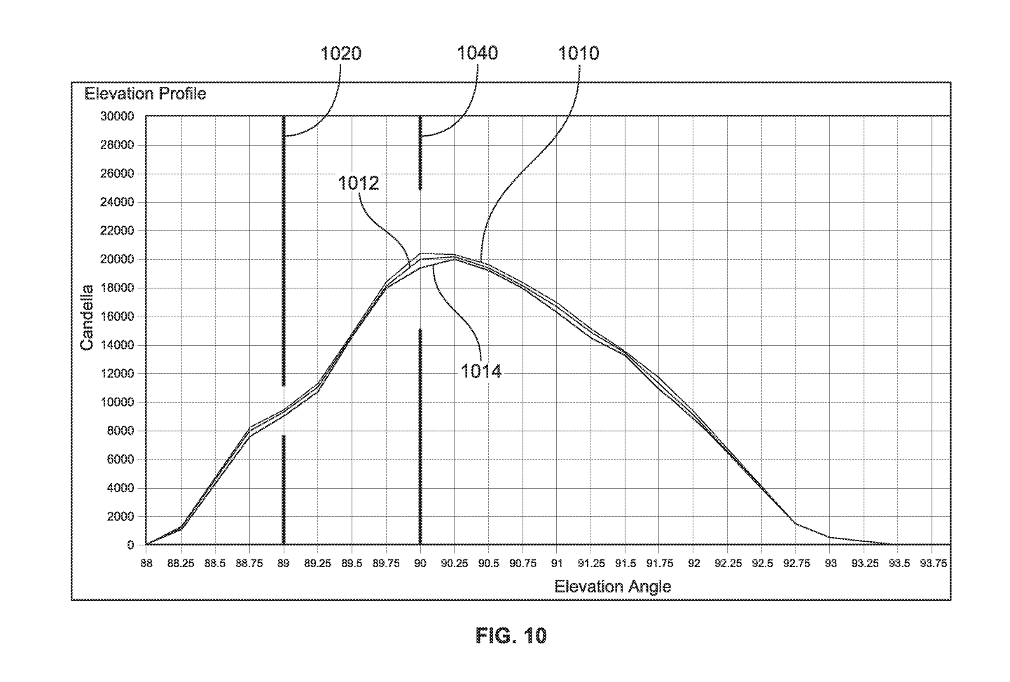

Ripple may be reduced by adding more light assemblies rather than using a single light assembly such as the light assembly 100 in FIG. 1. For example, a navigation light with two staggered layers of lights and reflectors may result in very low ripple capability compared to the navigation light 10 in FIG. 1 with a single layer of lights and reflectors. Such an arrangement would use two light assemblies similar to the light assembly 100. The two light assemblies are offset or staggered resulting in ripples being covered by light emitted from the opposite assembly. FIG. 10 is a graph showing the resulting intensity at different azimuth angles. The vertical axis represents the light output in candelas while the horizontal axis represents different azimuth angles. A maximum line 1010, an average line 1012 and a minimum line 1014 represent the light output of a light assembly based on the reflector surface design having the profiles shown in FIG. 8B fully arrayed in two staggered layers of eight reflectors in each layer. The sources are 1.3 mm wide and 120 mm long such as the LEDs 122 which are arranged in a line on each of the reflector segments. The double staggered light assembly arrangement results in less ripple as shown in FIG. 10 in comparison to the light output for a single light assembly. Further, such output is compliant with example ICAO requirements for brightness as shown by the lines 1010, 1012 and 1014 being within the acceptable windows at 89 degrees shown by a line 1030 and at 90 degrees as shown by a line 1040.

A single layer base with a single assembly 100 such as shown in FIGS. 1 and 2 results in more ripple and less margin to meet the stringent standard ICAO limits but is less complex with fewer components than the staggered multiple assembly light described above. Alternatively, a diffusing film with an elliptical spreading pattern may be added between the reflector assembly 108 and the transparent cover 36 over the light assembly 100 shown in FIG. 1 to homogenize the beam along the azimuth while not significantly disturbing the elevation pattern.

The designed reflectors therefore allow fewer optics for multiple LEDs per optic as shown in FIGS. 2-4. The application of integration of curves based on the ideal beam and the desired requirements produces a specific beam pattern meeting such requirements for application such as navigation lights. The application of x-profile modification, f(x) to provide an added degree of freedom in horizontal (azimuth) beam optimization provides better beams as shown by FIG. 9B.

The technique described above is faster and easier in that it does not require computationally linked surface generation and ray-trace software with large numbers of iteration cycles since the reflector design is tailored toward a desired beam requirement using an ideal model of the light source. The technique described above does not require the comprehensive merit function definitions and parametric surface optimization usually needed for free-form reflector design. Further, unlike known reflectors that are restricted to a single profile such as a conic shape which is linearly extruded or swept along a curve to generate a surface, the technique is not restricted to a single profile because it calculates optimal optical surfaces as a function of x and y position which need not be related by translation, sweep, or rotation operations. Optimization and adjustment of beam pattern in both elevation and azimuth may be done quickly as part of a deterministic design approach. Design control of azimuth beam shape is possible with the use of f(x,t) which is not possible with extruded or swept profiles. This is in contrast to traditional approaches in which reflector equations and other factors such as LED output may lead to a deterministic beam output, but whose controlling parameters do not relate to practical design constraints.

The design methods results in volume and energy efficient designs allowing many closely spaced LEDs to share reflective surfaces. The method also includes consideration for various required intensities, scalability of solutions, and for combining multiple colors. Other applications aside from navigation lights may be narrow beam application such as general illumination, surgical lighting, dental lighting, and architectural lighting.

The concepts and inventive matter described herein are not limited to beacon lights or obstruction lamps but may be applied to any illumination source requiring precise control of illuminating beam pattern. Although preferred embodiments have been depicted and described in detail herein, it will be apparent to those skilled in the relevant art that various modifications, additions, substitutions, and the like can be made without departing from the spirit of the invention and these are therefore considered to be within the scope of the invention as defined in the claims which follow.

What is claimed:

1. A light engine for a high intensity light comprising:
a first light emitting module having a light emitting diode mounted in a horizontal plane;
a reflector having a reflector surface in perpendicular relation to the light emitting diode, the reflector surface being defined by:
combining the integrals of a required beam emission specification with the integrals of the light emitting diode resulting in a reflector curve;
modifying the resulting reflector curve with focal length and curve based on horizontal plane position variables relative to the light emitting diode around an azimuth angle.

2. The light engine of claim 1, wherein the first light emitting diode is a white light diode.

3. The light engine of claim 1, wherein the first light emitting diode is one of a plurality of light emitting diodes, in substantially linear alignment.

4. The light engine of claim 1, further comprising a second light emitting diode emitting red light mounted in the horizontal plane.

5. The light engine of claim 1, wherein the reflector is part of a reflector assembly having a circular coverage.

6. The light engine of claim 1, wherein the modification of the reflector surface curve is determined by multiple iterations of different target beam profiles and functions f(x,Φ), wherein x is a horizontal position and Φ is an azimuth angle and resulting in a reflector surface whose cross-section varies with x or Φ positions along the reflector length.

7. The light engine of claim 1, wherein the light assembly emits a beam compliant with ICAO and FAA requirements, and wherein the design requirements are compliant with ICAO and FAA requirements.

8. The light engine of claim 1, wherein the function relative to the horizontal plane is a function defined as f(x, Φ)=fl+Σkₙ·Abs(x^{m})+Σ(sⱼ·x^{k})+u (x, y)+v (Φ, y).

9. The engine of claim 8, wherein the function is broken down into a plurality of sub-sections along the length of the reflector.

10. The engine of claim 1, wherein integrals of the required beam emission specification and the integrals of the light emitting diode are performed by a piece wise linear technique or a polynomial technique.

11. A navigation light compliant with narrow horizontal beam requirements, the navigation light comprising:
a first plurality of light sources arranged in a circular arrangement on a mounting surface to provide light at all radial angles;
a first reflector having a reflector surface in substantially perpendicular relationship to the mounting surface holding the plurality of light sources, the reflector surface designed by:
combining the integrals of a required beam emission specification with the integrals of at least one of the light sources resulting in a reflector curve;
modifying the resulting reflector curve with focal length and curve based on horizontal plane position variables relative to the light source around an azimuth angle.

12. The navigation light of claim 11, wherein the narrow beam requirements are ICAO and FAA compliant.

13. The navigation light of claim 11, wherein the light sources include a white light LED and a red light LED.

14. The navigation light of claim 11, wherein the function relative to the horizontal plane is a function defined as f(x, Φ)=fl+Σ kₙ·Abs(x^{m})+Σ (sⱼ·x^{k})+u (x, y)+v (Φ, y).

15. The navigation light of claim 11, wherein the function is broken down into a plurality of sub-sections along the length of the reflector.

16. The navigation light of claim 11, further comprising:
a second plurality of light sources arranged in a circular arrangement on a second mounting surface to provide light at all radial angles, the second plurality of light sources being staggered from the first plurality of light sources at a radial angle; and
a second reflector having a reflector surface in substantially perpendicular relationship to the mounting surface holding the second plurality of light sources

17. A method of fabricating a reflector having a reflector surface to reflect light rays from a light source in a narrow beam substantially parallel to a horizontal plane, the method comprising:
integrating a set of beam emission requirements over a range of angles of required light emission;
integrating a model of the light source emission;
determining a curve shape of the reflector surface based on the results of the light source emission integration; and
calculating the reflector surface based on functions including a horizontal plane position variable.

18. The method of claim 17, wherein the integrating of the required beam emission requirements and the integrals of the light source emission are performed by a piece wise linear technique or a polynomial technique.

19. The method of claim 17, wherein the beam emission requirements are ICAO and FAA compliant.

20. The method of claim 17, wherein the function relative to the horizontal plane is a function defined as f(x, Φ)=fl+Σ kₙ·Abs(x^{m})+(sⱼ·x^{k})+u (x, y)+v (Φ, y).

21. The method of claim 17, wherein the function is broken down into a plurality of sub-sections along the length of the reflector surface.
